(19) United States
(12) Patent Application Publication
(10) Pub. No.: US 2026/0289913 A1
(43) Pub. Date: Sep. 24, 2026

(54) Image Display System, Image Display Method, Control Device, and Computer Program

(71) Applicant: TEAMLAB INC., Tokyo (JP)

(72) Inventors: Toshiyuki INOKO, Tokyo (JP); Hayato KURUMATANI, Tokyo (JP)

(73) Assignee: TEAMLAB INC., Tokyo (JP)

(21) Appl. No.: 19/477,478

(22) PCT Filed: Apr. 22, 2024
(86) PCT No.: PCT/JP2024/015697

§ 371 Date: Oct. 21, 2025

(30) Foreign Application Priority Data
Apr. 26, 2023 (JP) 2023-072804

(51) Int. Cl. G06T 19/00; G06F 3/01

(52) U.S. Cl. CPC G06T 19/00; G06F 3/011; G06T 2200/24

(57) ABSTRACT

The purpose of the present invention is to provide an image display system with which it is possible to give a sense of immersion to a user and prolong the interest of the user. An image display system (100) comprises an image capture device (20), a display device (30), an operation terminal (40), and a control device that is connected to said devices and said terminal, the image display system (100) comprising: a generation unit that generates a three-dimensional virtual space including an operation object (PO), on the basis of image data that is acquired by the image capture device (20); a camera control unit that controls an overhead camera (OC) in the three-dimensional virtual space and an operation object line of sight or an object viewpoint camera (VC) that follows the operation object line of sight; a first display control unit that causes the display device (30) to display an image from the overhead camera (OC); a second display control unit that causes the operation terminal (40) to display an image from the object viewpoint camera (VC); and an object control unit that controls the operation of the operation object (PO) in the three-dimensional virtual space.

### TECHNICAL FIELD

The present invention relates to an image display system for displaying an image of a three-dimensional virtual space on a display device and an operation terminal. The present invention also relates to an image display method, a control device, and a computer program.

### BACKGROUND ART

The applicant of the present application has proposed an image display system that allows a user to demonstrate creativity and expressiveness by applying coloring and painting (Patent Literature 1). In the image display system of Patent Literature 1, when a colored picture or painting is scanned and imported as image data, an image of an object depicted in the picture or painting is generated, and the object image performs a predetermined operation on a display screen such as a large screen.

### CITATION LIST

### Patent Literature

Patent Literature 1: JP 2017-037614 A

### SUMMARY OF INVENTION

### Technical Problem

Incidentally, in the image display system of Patent Literature 1, after an object image is displayed on the screen, the object image basically only performs a predetermined operation according to a program. The user who creates the colored picture or the like that serves as the basis for this object image will be able to view the user's own object image from outside; however, there is a problem in that it is difficult to obtain a sense of immersion in the work just by viewing the object image from the outside. In addition, in this system, since the object image only performs a predetermined operation, there is also the problem that the user may easily become bored.

Accordingly, a main object of the present invention is to provide an image display system that gives a user a sense of immersion and can maintain the user's interest for a long period of time.

### Solution to Problem

As a result of thorough research into means for solving the problems of the above-mentioned conventional inventions, the inventors of the present invention discovered that by displaying object images within a three-dimensional virtual space on both a display screen such as a large screen and a display screen of a terminal owned by a user, and allowing the user to operate the object images using the terminal, it is possible to give the user a sense of immersion in a work and keep the user's interest for a long time. Based on the above findings, the present inventors have come to the realization that the problems associated with the conventional techniques can be solved, and have thus completed the present invention. In the following, the invention will be described in detail.

A first aspect of the present invention relates to an image display system. An image display system according to the present invention includes a display device, an operation terminal, and a control device. The display device may be one that projects an image onto a screen using a projector, or may be one that includes a display element such as a liquid crystal display or an organic EL display. The operation terminal is a terminal that is mainly held by a user, and may be a mobile information terminal such as a smartphone or a tablet terminal, or may be a laptop or desktop computer. The control device is connected to the display device and the operation terminal via a wired or wireless network. The control device may be connected to the display device and the operation terminal via a communication line such as the Internet, or may be connected to the display device and the operation terminal by a wired or wireless local area network (LAN). Note that the control device may be configured by a single computer (server device), or may be constructed by distributing functions among a plurality of computers.

Here, the control device has functional blocks such as a generation unit, a camera control unit, a first display control unit, a second display control unit, and an object control unit. These functional blocks are achieved by a processor of a computer that constitutes the control device. The generation unit generates a three-dimensional virtual space including an operable object. The operable object can be operated by an operation terminal owned by the user. Note that not only operable objects (Playable Objects) but also non-operable objects (Non-Playable Objects) may exist in the three-dimensional virtual space. The camera control unit controls an overhead camera and an object viewpoint camera in the three-dimensional virtual space. The overhead camera and the object viewpoint camera are virtual cameras that exist in the three-dimensional virtual space. The overhead camera is controlled so as to capture images within the three-dimensional virtual space mainly without depending on a specific object (particularly an operable object). On the other hand, the object viewpoint camera is controlled to capture an image of the three-dimensional virtual space from a first-person viewpoint from the line of sight of the operable object, or to capture an image of the three-dimensional virtual space from a third-person viewpoint so as to follow the operable object. The first display control unit causes the display device to display an image from the overhead camera. In addition, the second display control unit causes the operation terminal to display an image from the object viewpoint camera. More specifically, the second display control unit causes an image from an object viewpoint camera subordinate to a certain operable object to be displayed on the operation terminal that is operating the operable object. The object control unit controls operation of the operable object in the three-dimensional virtual space.

As configured above, in the present invention, two types of virtual cameras, namely, an overhead camera and an object viewpoint camera, are provided within a single three-dimensional virtual space, and an image from the overhead camera is displayed on a display device, and an image from the object viewpoint camera is displayed on an operation terminal. Furthermore, the operable object in the three-dimensional virtual space can be operated freely by this control terminal. This allows the operation of the operable object operated by the operation terminal to be synchronized with the operation of the operable object displayed on the display device. In other words, when a certain operable object is operated by the operation terminal, the operable object displayed on the display device also performs the same operation. Therefore, the user can feel immersed as if the user were the operable object and had entered the three-dimensional virtual space displayed by the display device. In addition, by allowing the user to freely operate the operable object, it is possible to keep the user interested for a long time without causing the user to become bored.

The system according to the present invention further includes an image capture device that scans a physical medium on which an object is drawn and captures image data. In this case, the generation unit of the control device generates an operable object within a three-dimensional virtual space based on image data captured by the image capture device. For example, when a user applies color to an object by coloring or the like, this object becomes an image and is taken into the three-dimensional virtual space, and functions as an operable object. The user can then freely operate the operable object that the user has colored in the three-dimensional virtual space via the operation terminal. Thus, it is possible to provide the user with a more immersive experience.

The system according to the present invention preferably further includes a detection device capable of detecting a contact position on the display screen of the display device. In this case, the control device may further include a terminal control unit. The terminal control unit generates a reaction command based on detection information from the detection device, and transmits the reaction command to the operation terminal. In this case, it is preferable that the operation terminal includes an output unit that performs an output in response to the reaction command. Examples of the output unit include output devices such as a display, a vibrator, and a flashlight. For example, when the terminal control unit has determined that the contact position detected by the detection device corresponds to an operable object displayed on the display screen, the terminal control unit generates a reaction command for the operation terminal that is operating the operable object. For example, when an operable object being operated by one user's operation terminal is touched by another user (viewer) on the display screen of a display device, some kind of display may be made on the display screen of the operation terminal, a vibrator within the operation terminal may vibrate, a specific sound may be output from the speaker of the operation terminal, or the flashlight of the operation terminal may turn on. This allows the user operating the operable object to feel as if the operable object displayed on the user's own operation terminal is synchronized with the operable object displayed on the display screen of the display device, providing an even higher sense of immersion. In addition, for example, when the terminal control unit has determined that the contact position detected by the detection device corresponds to a specific game item on the display screen, the terminal control unit may give the action of that game item to an operable object existing in the three-dimensional virtual space. In this case, the terminal control unit generates a reaction command for the operation terminal that is operating the operable object on which the game item acts. As a result, some kind of display may appear on the display screen of the operation terminal to which the reaction command was given, a vibrator in the operation terminal may vibrate, a specified sound may be output from the speaker of the operation terminal, or a flashlight of the operation terminal may turn on. In addition, when the terminal control unit has determined that the contact position detected by the detection device corresponds to a certain operable object on the display screen, the terminal control unit is also able to generate a reaction command for an operation terminal that is operating an operable object other than the aforementioned operable object. In this way, the contact position detected by the detection device is not limited to the operable object, but may be other game items, and the like. Moreover, the operation terminal to which the reaction command is given is not limited to the operation terminal that operates the operable object whose contact position has been detected by the detection device.

In the system according to the present invention, the operation terminal preferably has an imaging unit. In this case, the operation terminal transmits the captured image captured by this imaging unit to the control device. It is also preferable that the control device further includes an image analysis unit and an object management unit. The image analysis unit analyzes a captured image received from the operation terminal and determines whether or not an operable object is included in the captured image. In a case in which the image analysis unit has determined that an operable object is included in the captured image, the object management unit grants operation authority for the operable object to the operation terminal that has captured the image of the operable object. This allows the operation terminal to operate the operable object included in the captured image. It is possible to display a list of operable objects on the operation terminal and allow the user to select the operable object that the user wants to operate; however, when there are a large number of selectable operable objects, it becomes difficult to find the object the user wants to operate from the list. On the other hand, in a case in which a user sees an operable object that the user likes displayed on the display screen of a display device, the user can obtain operation authority for that operable object simply by capturing an image of that operable object, thereby greatly improving user convenience.

A second aspect of the present invention is a computer program for an operation terminal. A computer program according to the second aspect causes an information communication terminal to function as an operation terminal in the image display system according to the first aspect described above. The program may be a program that can be downloaded via the Internet, or may be a program that is non-temporarily recorded on a recording medium such as a CD-ROM.

A third aspect of the present invention relates to a control device connected to the display device, the operation terminal, and the image capture device via a wired or wireless network. Note that the image capture device is a device for capturing image data by scanning a physical medium on which an object is drawn. The control device includes: a generation unit that generates a three-dimensional virtual space including an operable object; a camera control unit for controlling, in the three-dimensional virtual space, an overhead camera and an object viewpoint camera that follows the line of sight of the operable object; a first display control unit that displays an image from the overhead camera on a display device; a second display control unit that displays an image from the object viewpoint camera on an operation terminal; and an object control unit that controls the operation of the operable object in the three-dimensional virtual space. In addition, the same functions as the control device in the system according to the first aspect described above may be used as the preferable functions of the control device.

A fourth aspect of the present invention is a program for computers. A program according to the fourth aspect causes a computer to function as the control device according to the third aspect described above. The program may be a program that can be downloaded via the Internet, or may be a program that is non-temporarily recorded on a recording medium such as a CD-ROM.

A fifth aspect of the present invention relates to an image display method executed by a system including a display device, an operation terminal, an image capture device, and a control device connected to the display device, the operation terminal, and the image capture device via a wired or wireless network. In the method according to the present invention, the control device generates a three-dimensional virtual space including an operable object (generation step). In addition, the control device also controls the overhead camera and the line of sight of the operable object or an object viewpoint camera that follows the line of sight of the operable object in the three-dimensional virtual space (camera control step). The control device also causes the display device to display an image from the overhead camera (first display control step). Moreover, the control device causes the image from the object viewpoint camera to be displayed on the operation terminal (second control step). Further, the control device controls the operation of the operable object in the three-dimensional virtual space (object control step). As other preferable steps of the image display method, the same steps as those executed by the system according to the first aspect described above can be adopted.

### Advantageous Effects of Invention

With the present invention, it is possible to provide an image display system that gives a user a sense of immersion and can keep the user's interest for a long period of time.

### BRIEF DESCRIPTION OF DRAWINGS

FIG. 1 illustrates an overview of an image display system.

FIG. 2 is a block diagram illustrating an example of a configuration of an image display system.

FIGS. 3A and 3B illustrate main features of the image display system.

FIG. 4 is a sequence diagram showing an example of a display process of an operable object.

FIG. 5 is a sequence diagram showing an example of a reaction process of the operation terminal.

FIG. 6 is a sequence diagram showing an example of a process for granting an operation authority for an operable object to an operation terminal.

FIGS. 7A to 7D show examples of an object viewpoint camera.

### DESCRIPTION OF EMBODIMENTS

Hereinafter, preferred embodiments of the present invention will be described with reference to the drawings. The present invention is not limited to the embodiments described below, and also includes appropriate modifications of the embodiments described below within the scope obvious to those skilled in the art.

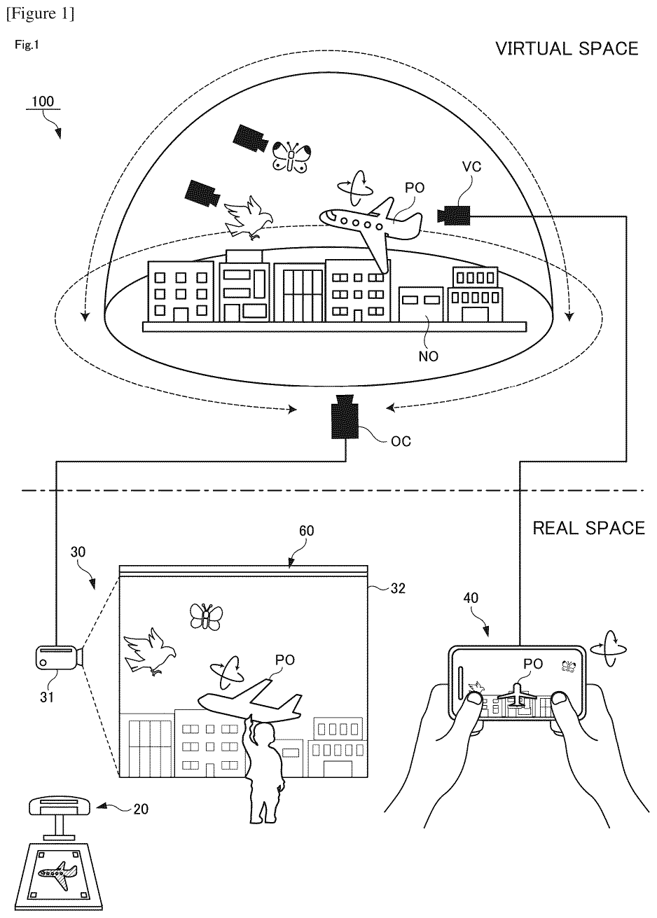

FIG. 1 illustrates a schematic overview of an image display system 100 according to the present invention. As illustrated in FIG. 1, an operable object PO that can be operated by a user exists in a three-dimensional virtual space. This operable object PO is associated with a unique virtual object viewpoint camera VC, and images (including still images and videos) captured by this object viewpoint camera VC are displayed on a display screen of an operation terminal 40, such as a smartphone, owned by the user. The user can use the operation terminal 40 to operate the operable object PO in the three-dimensional virtual space while checking the image displayed on the operation terminal 40. Note that in the three-dimensional virtual space, there exists a plurality of operable objects PO each having its own object viewpoint camera VC, and each operable object PO is controlled by a different user. In addition to the operable object PO, non-operable objects NO also exist in the three-dimensional virtual space.

On the other hand, in the three-dimensional virtual space, in addition to the object viewpoint camera VC associated with the operable object PO, there exists a virtual overhead camera OC that overlooks this virtual space. This overhead camera OC is not subordinate to an individual operable object PO or a non-operable object NO, but is controlled so as to capture an overall image of a plurality of operable objects PO or a plurality of non-operable objects NO. For example, in the example shown in FIG. 1, a dome-shaped space is provided in a three-dimensional virtual space, and an operable object PO and a non-operable object NO are provided in this dome-shaped space. In this case, the overhead camera OC moves around the dome-shaped space or moves above the dome-shaped space, capturing an image of the operable object PO and the non-operable object NO that exist within the dome-shaped space. In addition, the overhead camera OC can also enter this dome-shaped space and capture images of the operable object PO and the like.

The image captured by this overhead camera OC is output to a display device 30. In the example shown in FIG. 1, the display device 30 includes a projector 31 and a large screen 32. The projector 31 projects an image captured by the overhead camera OC onto a screen 32. At this time, the overhead camera OC and the object viewpoint camera VC may be capturing images of the same operable object PO in the same three-dimensional virtual space. In this case, when the user operates the operable object PO using the operation terminal 40, the movement of the operable object PO is displayed on the operation terminal 40 and, at the same time, the movement of the operable object PO is also displayed on the display screen of the display device 30. As a result, it can be said that the operable object PO displayed on the operation terminal 40 and the operable object PO displayed on the display screen of the display device 30 are synchronized.

Moreover, an object drawn or colored by the user on a physical medium such as printing paper can be captured as image data by a scanner and used as an operable object PO in a three-dimensional virtual space. That is, the system 100 includes an image capture device 20, and an operable object PO is generated based on an image captured by the image capture device 20. For details on such a mechanism, refer to Patent Literature 1 (JP 2017-037614 A). As a result, the user is able to have the experience of manipulating an object that he or she has drawn.

In addition, the user (viewer) can also touch the operable object PO displayed on the display screen (screen 32, or the like) of the display device 30. The touch position on the display screen is detected by a detection device 60, and it is determined whether the viewer has touched the operable object PO. In a case in which the viewer has touched the operable object PO, the operable object PO may perform a predetermined action in the three-dimensional virtual space. Furthermore, in a case in which a viewer has touched an operable object PO, contact information may be transmitted to the operation terminal 40 that is operating the operable object PO, and the operation terminal 40 may output a predetermined reaction.

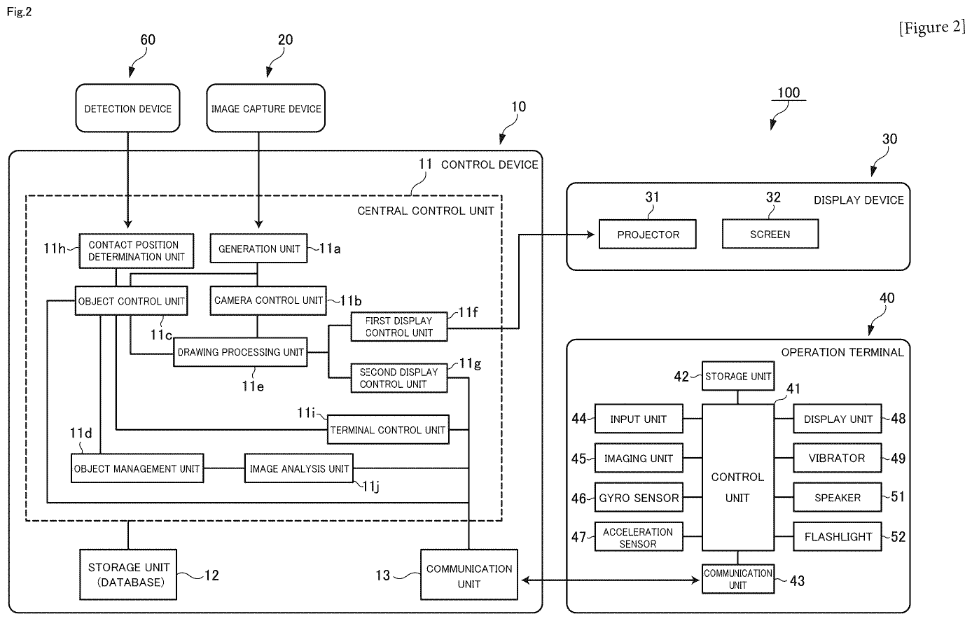

FIG. 2 is a block diagram showing an example of a functional configuration of the image display system 100 according to the present invention. As shown in FIG. 2, the image display system 100 includes, as main devices, a control device 10, an image capture device 20, a display device 30, an operation terminal 40, and a detection device 60.

The control device 10 is a computer that is responsible for the overall control of the image display system 100, and is mainly responsible for generating a three-dimensional virtual space and drawing images to be displayed on the display device 30 and the operation terminal 40. The control device 10 is connected to each of the image capture device 20, the display device 30, the operation terminal 40, and the detection device 60 via wired or wireless connection. In the present embodiment, the control device 10 is connected to the image capture device 20, the display device 30, and the detection device 60 via a local area network (LAN). On the other hand, the control device 10 is wirelessly connected to the operation terminal 40 via the Internet. However, in an environment where communication with an external base station is poor, the control device 10 and the operation terminal 40 can be connected via a wireless LAN.

The control device 10 mainly includes a central control unit 11, a storage unit 12, and a communication unit 13. The central control unit 11 is composed of, for example, a processor and a memory. Examples of the processor include a well-known CPU and GPU. The processor performs predetermined calculation processing and image processing in accordance with programs and data stored in the memory, and executes various control processes while writing the results of the processing into the working space of the memory. The memory is composed of a volatile memory such as a random access memory (RAM), and is used for the calculation processing by the processor. The storage unit 12 is an element (storage) for storing data that is mainly used for processing by the central control unit 11. In addition, the storage unit 12 may store programs used for processing by the processor of the central control unit 11. The storage unit 12 is composed of a non-volatile memory such as a read only memory (ROM) or a flash memory, and a hard disk drive (HDD). The communication unit 13 is an element for transmitting and receiving data to and from the operation terminal 40 via the Internet, and is only required to be capable of transmitting and receiving data by wire or wirelessly. In a case of performing wireless communication, a communication module conforming to a known wireless communication standard such as 4G, 5G, or Wi-Fi (registered trademark) can be adopted as the communication unit 13.

In the present embodiment, when the processing executed by the central control unit 11 is explained as functional blocks, the central control unit 11, as illustrated in FIG. 1, includes a generation unit 11a, a camera control unit 11b, an object control unit 11c, an object management unit 11d, a drawing processing unit 11e, a first display control unit 11f, a second display control unit 11g, a contact position determination unit 11h, a terminal control unit 11i, and an image analysis unit 11j.

The generation unit 11a mainly performs calculations to generate a three-dimensional virtual space. This three-dimensional virtual space includes operable objects and non-operable objects as illustrated in FIG. 1. For this reason, the generation unit 11a also performs calculations to generate operable objects and non-operable objects. In addition, as illustrated in FIG. 1, in a case in which a dome-shaped space in which each object is placed is provided in a three-dimensional virtual space, calculations for generating this dome-shaped space are performed by the generation unit 11a.

The camera control unit 11b controls the object viewpoint camera and the overhead camera in the three-dimensional virtual space. For example, in a case in which the object viewpoint camera is used to capture an image of the operable object from a third-person viewpoint, the camera control unit 11b controls the object viewpoint camera so that the operable object is always within the imaging range of the object viewpoint camera while causing the object viewpoint camera to follow the movement of the operable object. In addition, in a case in which the object viewpoint camera is at a first-person viewpoint of the operable object, the object viewpoint camera is controlled so that the object viewpoint camera always captures images of the three-dimensional virtual space from the line of sight of the operable object. Moreover, as for the overhead camera, the camera control unit 11b may control the overhead camera so that the camera moves along a predetermined trajectory within the three-dimensional virtual space, for example. As described above, in a case in which a dome-shaped space is formed within a three-dimensional virtual space, the camera control unit 11b can capture images of operable objects and non-operable objects that exist within the dome-shaped space by moving the overhead camera around the dome-shaped space or by moving it above the dome-shaped space.

The object control unit 11c controls operable objects and non-operable objects that exist in the three-dimensional virtual space. The object control unit 11c mainly controls the operation of the operable object in accordance with an operation command from the operation terminal 40. Moreover, the object control unit 11c controls the operation of the operable object or the non-operable object based on detection information from the detection device 60. In addition, the operation rules for the operable objects and non-operable objects are stored in the memory or storage unit 12. For example, the object control unit 11c may control the operation of each object according to predetermined operation rules, such as causing each object to perform a collision action when two operable objects come into contact with each other in the three-dimensional virtual space, or causing a non-operable object to perform an avoidance action when an operable object is about to come into contact with a non-operable object. In addition, in a case in which the operable object is not receiving an operation command from the operation terminal 40, the object control unit 11c may cause the operable object to operate according to a predetermined operation program.

The object management unit 11d manages operable objects and non-operable objects that exist in the three-dimensional virtual space. More specifically, the object management unit 11d performs a process of granting the operation authority for the operable object to the operation terminal 40. For example, each operable object is assigned unique identification information (ID), and the object management unit 11d associates the identification information (ID) of the operable object with identification information (IP address, and the like) of the operation terminal 40 that has been granted authority to operate the operable object, and records the association in a database in the storage unit 12. This allows the database to manage which operation terminal 40 is operating which operable object. Moreover, the object management unit 11d identifies the operable objects and non-operable objects that currently exist within the three-dimensional virtual space. Furthermore, the object management unit 11d may be configured to manage objects that can exist simultaneously in a three-dimensional virtual space. For example, in a case in which an upper limit is set on the number of operable objects and non-operable objects that can appear in the three-dimensional virtual space at one time, when a new operable object or non-operable object is generated in the three-dimensional virtual space, the object management unit 11d deletes each object in order from the oldest to manage the number of objects currently existing in the three-dimensional virtual space so as to be within the upper limit.

The drawing processing unit 11e performs a drawing process for the three-dimensional virtual space and each object (operable object and non-operable object), the images of which are captured by the object viewpoint camera and the overhead camera. More specifically, the drawing processing unit 11e converts the three-dimensional virtual space expressed in a world coordinate system (X, Y, Z) into a screen coordinate system (U, V) from the camera positions of the object viewpoint camera and the overhead camera to generate a two-dimensional image. The two-dimensional image from the camera position of the overhead camera is an image to be displayed on the display device 30. In addition, the two-dimensional image from the camera position of the object viewpoint camera is an image to be displayed on the operation terminal 40. In addition, the drawing processing unit 11e may process the three-dimensional virtual space into an image suitable for display on the display device 30 or the operation terminal 40 using known 3DCG processing techniques, rather than directly converting the three-dimensional virtual space into a two-dimensional image.

The first display control unit 11f outputs a two-dimensional image from the position of the overhead camera to the display device 30 via a predetermined I/O interface, and causes the display device 30 to display this two-dimensional image. On the other hand, the second display control unit 11g transmits a two-dimensional image from the position of the object viewpoint camera to the operation terminal 40 via the communication unit 13, and causes the operation terminal 40 to display this two-dimensional image.

The contact position determination unit 11h determines the contact position of a user (viewer) or the like on the display screen of the display device 30 based on the detection information by the detection device 60. For example, the contact position determination unit 11h constantly grasps the correspondence between the x and y coordinates on the display screen of the display device 30 and the x and y coordinates in the two-dimensional image displayed on the display device 30. Therefore, when the detection device 60 detects the position (x and y coordinates) where the viewer touched the display screen of the display device 30, the contact position determination unit 11h identifies the position (x and y coordinates) where the viewer touched the two-dimensional image displayed on the display device 30. As a result, it is possible for the contact position determination unit 11h to determine, for example, whether or not the viewer has touched an operable object or a non-operable object on the display screen of the display device 30.

The terminal control unit 11i generates a reaction command related to the control of the output unit of the operation terminal 40 (the display unit 48, the vibrator 49, the speaker 51, the flashlight 52, and the like). The reaction command generated by the terminal control unit 11i is transmitted to the operation terminal 40 via the communication unit 13. In the present embodiment, for example, when an operable object being operated by a certain user via the operation terminal 40 is touched on the display screen of the display device 30 by another user (viewer), a reaction command is generated for that operation terminal 40.

The image analysis unit 11j mainly analyzes images captured by an imaging unit 45 of the operation terminal 40. In the present embodiment, the image analysis unit 11j determines whether or not an operable object is included in a captured image of the operation terminal 40. Furthermore, in a case in which an operable object is included in the captured image of the operation terminal 40, the image analysis unit 11j performs individual identification of the operable object. More specifically, the image analysis unit 11j may identify the operable object from features such as the shape and color of the operable object included in the captured image. In addition, when an operable object is generated, a marker (digital watermark) for individual identification may be embedded in advance, and the marker of the operable object included in the captured image may be analyzed to identify the individual operable object.

The image capture device 20 is a device for capturing image data by scanning a physical medium, such as a printing paper on which an object is drawn. Note that in a case in which a marker for identifying an object is drawn on the physical medium, the image capture device 20 scans a surface of the physical medium on which the object and the marker are drawn and converts the object and the marker into image data. A known scanner or camera may be used as the image capture device 20. The image capture device 20 converts the scanned image into data in a known format such as GIF or JPEG and outputs the data to the control device 10.

Furthermore, based on the image data captured by the image capture device 20, the generation unit 11a of the control device 10 can generate an operable object. More specifically, the generation unit 11a performs an analysis to identify the type of object included in the image data. For example, as in Patent Literature 1, in a case in which a marker corresponding to an object is attached to the surface of a physical medium (paper for coloring), the generation unit 11a can analyze the marker included in the image data to identify the type of object. Moreover, the generation unit 11a also performs a drawing process to extract an area in which an object is drawn from the image data and generate an object image from which unnecessary parts such as a background have been removed. For example, in a case in which a marker is printed on each of the four corners of the surface of a physical medium (paper for coloring), the generation unit 11a determines the positions of the four markers included in the image data, defines a rectangular area with the four markers as vertices thereof, and removes the area outside the rectangular area. As a result, a rectangular image in which the object is drawn can be cut out from the image data. After that, the generation unit 11a then extracts the outlined and colored portions of the object from within the rectangular area, and generates an image of the operable object. For example, the generation unit 11a may generate an image of the operable object by extracting the contour of the object by applying a mask corresponding to the type of object to the rectangular image, or may generate an image of the operable object by performing a chroma key compositing process to extract colored parts from the rectangular image and make white parts (colorless parts) transparent. Moreover, the generation unit 11a adds a predetermined operation program corresponding to the type of the object to the image of the operable object generated as described above. This allows the operable object to perform an operation according to a predetermined operation program even before it is operated by the user. After the user starts to operate the operable object, the operation command from the user takes precedence over the operation program in carrying out the operation.

The display device 30 displays a two-dimensional image from the viewpoint of the overhead camera under the control of the control device 10. In the present embodiment, the display device 30 includes a projector 31 and a screen 32. The projector 31 receives the image drawn by the control device 10 and projects the image onto the surface of the screen 32. A known projector and screen may be used as the projector 31 and the screen 32. Note that the screen 32 may be replaced by a flat wall or the like. Furthermore, the display device 30 may also be a large monitor, a liquid crystal display, an organic EL display, or the like. However, it is preferable to employ the projector 31 and the screen 32 as the display device 30, since this allows images to be displayed on a large screen easily and at low cost.

The operation terminal 40 is a terminal device that is held by a user who operates an operable object. An example of the operation terminal 40 is a mobile information terminal such as a smartphone or a tablet terminal. The operation terminal 40 includes a control unit 41, a storage unit 42, a communication unit 43, an input unit 44, an imaging unit 45, a gyro sensor 46, an acceleration sensor 47, a display unit 48, a vibrator 49, a speaker 51, a flashlight 52, and the like. Additionally, the operation terminal 40 may include known modules that are included in general smartphones and tablet terminals.

The control unit 41 performs overall control of the other elements included in the operation terminal 40. The control unit 41 is composed of a known processor such as a CPU, and a known memory such as a RAM. The processor of the control unit 41 loads an application program stored in the storage unit 42 into the memory, and controls other elements in accordance with this application program. The storage unit 42 is an element for storing data used in the processing by the control unit 41. More specifically, the storage unit 42 stores an application program for causing a mobile information terminal such as a general smartphone to function as the operation terminal 40 in this system. The application program stored in the storage unit 42 is read out by the control unit 41, and processing according to the program is executed. Note that the storage unit 42 may also store a plurality of other application programs. The storage unit 42 of the operation terminal 40 can be achieved by a non-volatile memory such as an HDD or SSD. The communication unit 43 is an element for communicating with the control device 10 via a communication line such as the Internet.

The input unit 44 is an element for inputting operation information by the user to the operation terminal 40. A known input device such as a touch panel, a mouse, a keyboard, or a stylus pen may be used as the input unit 44. Note that the input unit 44 may be physically separable from the operation terminal 40, in which case the input unit 44 is connected to the operation terminal 40 via a short-range wireless communication standard such as Bluetooth (registered trademark). Furthermore, a touch panel display may be configured by placing a touch panel (input unit 44) on a front surface of a display (display unit 48).

The imaging unit 45 is an element for acquiring image data of a still image or moving images. As the imaging unit 45, a known digital camera built into the operation terminal 40 may be used. The image data acquired by the imaging unit 45 is sent to the control unit 41 where the image data is subjected to a predetermined calculation process, and then stored in the storage unit 42. A camera is achieved by, for example, a lens, a mechanical shutter, a shutter driver, a photoelectric conversion element such as a CCD image sensor unit or a CMOS image sensor unit, a digital signal processor (DSP) that reads the amount of charge from the photoelectric conversion element and generates image data, an IC memory, and the like.

The gyro sensor 46 is a sensor for continuously measuring the angular velocity of the operation terminal 40. An example of the gyro sensor 46 is a three-axis vibration gyro sensor that vibrates an element to detect angular velocity from a Coriolis force acting on the element. The acceleration sensor 47 is a sensor for continuously measuring acceleration of the operation terminal 40.

The acceleration sensor 47 detects three-dimensional inertial motion (translational motion in three orthogonal axial directions), and a three-axis acceleration sensor can be used. A known method such as a frequency change method, a piezoelectric method, a piezoresistance method, or a capacitance method may be used as the measurement method of the acceleration sensor 47.

The display unit 48 is an element for displaying predetermined images (still images and moving images), and is configured with a known display device such as a liquid crystal display or an organic EL display. The vibrator 49 is an element for vibrating the operation terminal 40. The speaker 51 is an element for outputting sound. The flashlight 52 is an element for generating light, and is configured with a known light emitting element such as an LED. The display unit 48, the vibrator 49, the speaker 51, and the flashlight 52 function as an output unit of the operation terminal 40. The control unit 41 of the operation terminal 40 may drive these output units in response to a reaction command generated by the terminal control unit 11i of the control device 10 described above.

As shown in FIG. 1, the detection device 60 detects the presence of a person near the display screen (screen 32) of the display device 30 and the contact position on the display screen (screen 32). Any of various known sensors, such as a range sensor, an infrared sensor, an optical sensor, an ultrasonic sensor, a capacitance sensor, a pressure sensor, a sound sensor, and a temperature sensor may be used as the detection device 60. Furthermore, it is also possible to use a combination of a plurality of sensors with different functions, such as an infrared sensor and a pressure sensor as the detection device 60. In particular, it is preferable that the detection device 60 employs a range sensor and detects the contact position (coordinate position on the screen 32) when a user (viewer) touches the screen 32. The range sensor is a two-dimensional scanning type optical distance measuring sensor that emits inspection light (laser) along the screen 32 and measures the distance and angle to the contact position by the viewer by scanning the inspection light. The information detected by the range sensor is transmitted to the control device 10. When the position coordinates of the range sensor in real space are known, the position coordinates of the object in real space can be detected by measuring the distance and angle to the object that comes into contact with the light emitted from the range sensor. Such detection information by the detection device 60 is sent to the control device 10 in real time and is used, for example, to control the operation of the operable object and the non-operable object.

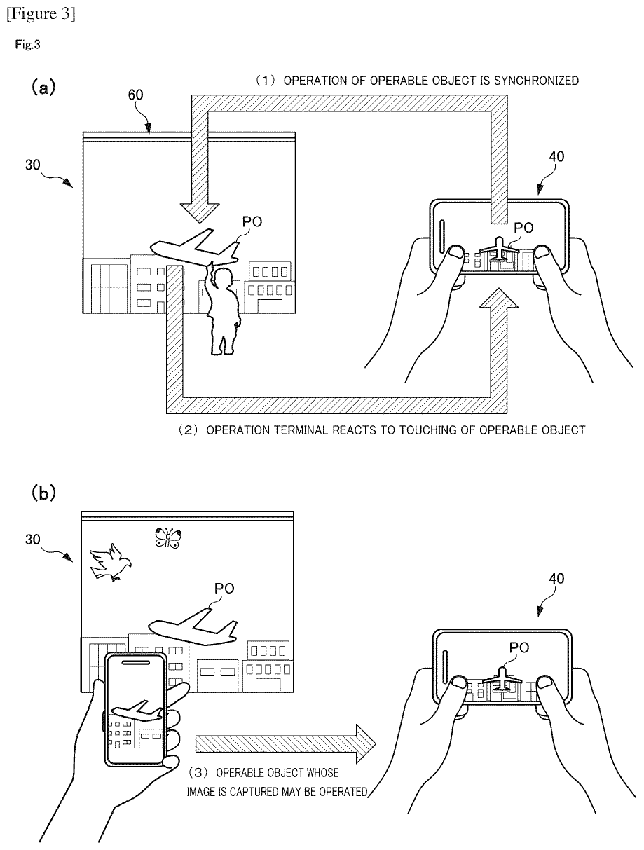

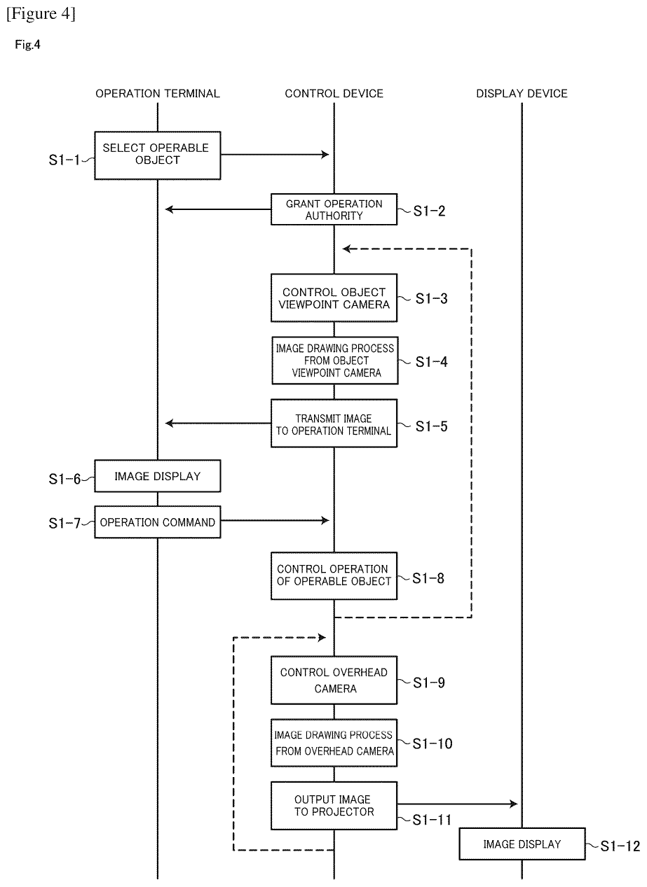

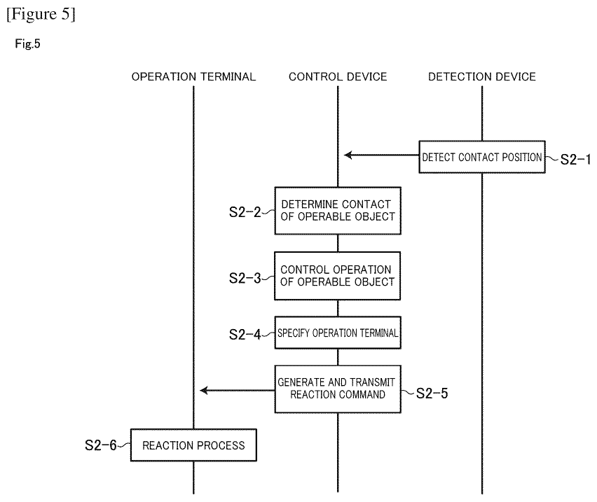

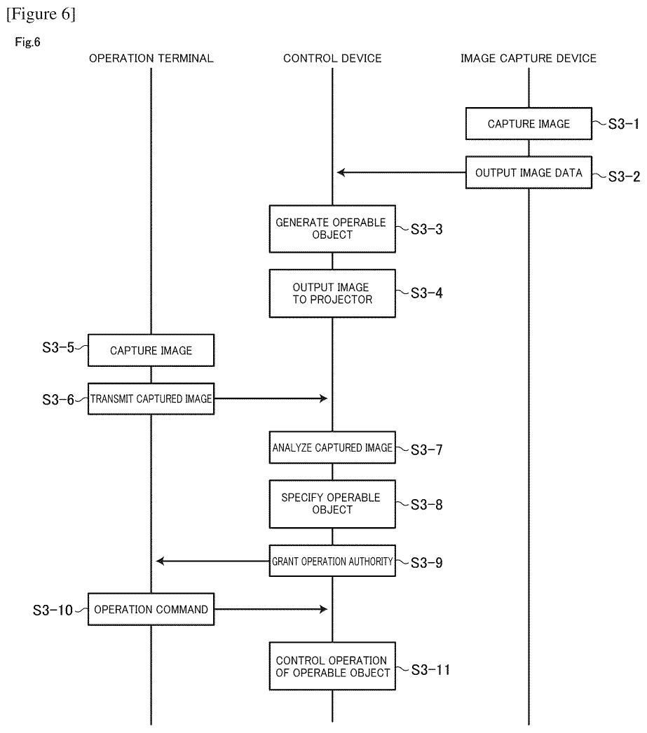

FIG. 3 schematically shows main features of the image display system 100 according to the present embodiment. A first feature is that the operation of the operable object PO displayed on the operation terminal 40 and operated by the user is synchronized with the operation on the display screen of the display device 30 as well. A second feature is that when the user touches the operable object PO on the display screen of the display device 30, the operation terminal 40 that is operating the operable object PO reacts by, for example, vibrating. A third feature is that, in a case in which an unoperated operable object PO is displayed on the display screen of the display device 30, and the user captures an image of the operable object PO with the camera of the operation terminal 40, the operable object PO can be operated on the operation terminal 40. A sequence for achieving each of these features will be described below. FIG. 4 shows a sequence of the first feature, FIG. 5 shows the sequence of the second feature, and FIG. 6 shows the sequence of the third feature.

FIG. 4 shows an example of the first feature described above, that is, a process for synchronizing the image display of the operable object and the image display of the image.

First, the user selects an operable object that the user wishes to operate via the operation terminal 40 (step S1-1). At this time, for example, a list of operable objects is displayed on the display unit 48 of the operation terminal 40. The user can select one operable object that the user wishes to operate from the list. The operation terminal 40 transmits to the control device 10 identification information (ID) unique to the operable object selected by the user and identification information (such as an IP address) unique to this operation terminal 40.

Next, the control device 10 grants operation authority for the operable object selected by the user to the operation terminal 40 of that user (step S1-2). More specifically, the object management unit 11d of the control device 10 associates the identification information (ID) unique to the operable object received from the operation terminal 40 with the identification information (such as an IP address) unique to the operation terminal 40 and registers the result in the database of the storage unit 12. As a result, when the control device 10 receives an operation command for an operable object from the operation terminal 40, the control device 10 can determine that the operation command is for an operable object associated with the operation terminal 40 in the database. Note that when the operation authority for the operation terminal 40 is to be cancelled, the identification information of the operation terminal 40 is deleted from the database of the storage unit 12.

Next, the camera control unit 11b of the control device 10 assigns an object viewpoint camera to the operable object selected by the user, and controls this object viewpoint camera to capture images of the three-dimensional virtual space from a predetermined viewpoint (step S1-3). The viewpoint and width of the field of view of the object viewpoint camera can be set for each type of operable object.

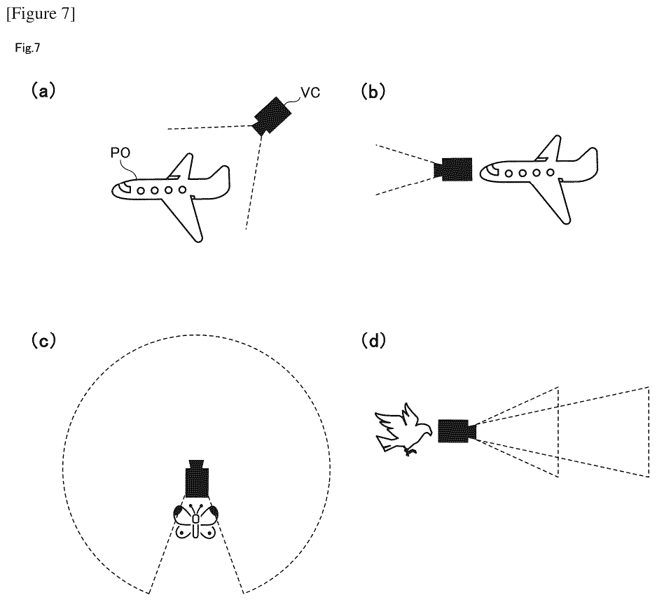

FIGS. 7A to 7D show examples of the correspondence between the operable object PO and the object viewpoint camera VC. In FIG. 7A, a third-person object viewpoint camera VC is assigned to an airplane-shaped operable object PO. In this case, the camera control unit 11b controls the object viewpoint camera VC to be positioned obliquely above and behind the operable object PO and to capture an image of the operable object PO. In FIG. 7B, a first-person object viewpoint camera VC is assigned to an airplane-shaped operable object PO. In this case, the camera control unit 11b controls the object viewpoint camera VC to be positioned in front of the operable object PO and to capture an image in front of the operable object PO. In the first-person viewpoint, the operable object PO is not within the field of view of the object viewpoint camera VC. Note that the user may be allowed to arbitrarily select whether the object-viewpoint camera VC is a third-person viewpoint (FIG. 7A) or a first-person viewpoint (FIG. 7B).

Moreover, In FIG. 7C, a first-person wide-angle object viewpoint camera VC is assigned to a butterfly-shaped operable object PO. A viewing angle of a typical object viewpoint camera VC is generally 40 to 50 degrees, but as shown in FIG. 7C, the viewing angle of the object viewpoint camera VC can also be 90 to 360 degrees, or more specifically, 180 to 340 degrees. In a case in which such a wide-angle object viewpoint camera VC is set, the image displayed on the display screen of the operation terminal 40 will be distorted on both the left and right edges of the screen. In FIG. 7D, a zoomable first-person object viewpoint camera VC is assigned to a bird-shaped operable object PO. For example, when the user of the operation terminal 40 touches the display screen, the field of view of the object-viewpoint camera VC is zoomed centered around the touched position, and when the user touches the display screen again, the zoom is released. Although not shown in the drawings, it is also possible to assign a plurality of object viewpoint cameras VC with different viewing directions with respect to one operable object PO (three or more cameras are also possible). In a case in which two or more object viewpoint cameras VC are set in this way, images from two or more viewpoints are displayed simultaneously on the display screen of the operation terminal 40.

Next, the drawing processing unit 11e of the control device 10 draws a two-dimensional image from the viewpoint of the object viewpoint camera (step S1-4). That is, the drawing processing unit 11e converts the three-dimensional virtual space expressed in the world coordinate system (X, Y, Z) into the screen coordinate system (U, V) from the object viewpoint camera, and generates a two-dimensional image. After that, the second display control unit 11g of the control device 10 transmits the two-dimensional image thus generated to the operation terminal 40 via the communication unit 13 (step S1-5).

Next, the operation terminal 40 displays the two-dimensional image received from the control device 10 on the display unit 48 (step S1-6). This two-dimensional image is from the viewpoint of an object viewpoint camera associated with the operable object, and thus the user can operate the operable object while viewing this two-dimensional image.

The user uses the operation terminal 40 to operate the operable object (step S1-7). There are no particular limitations on the method of operating the operable object, and any known method can be used. For example, in a case in which the operation terminal 40 has a touch panel display, a cursor may be displayed on the touch panel display, and the user may operate an operable object by touching the cursor. In addition, in a case in which the operation terminal 40 has a gyro sensor 46 or an acceleration sensor 47, these sensors may be used to detect the acceleration and angular velocity when the user tilts the operation terminal 40, and the detected acceleration and angular velocity may be used as operation information for the operable object. The control unit 41 of the operation terminal 40 generates an operation command for the operable object based on information thus input by the user, and transmits the operation command to the control device 10.

Next, the object control unit 11c of the control device 10 controls the operation of the operable object in the three-dimensional virtual space based on the operation command received from the operation terminal 40 (step S1-8). For example, the object control unit 11c may cause the operable object to perform a tilt operation, a pan operation, forward movement, backward movement, acceleration, deceleration, or perform other actions (such as an attack or jump) in response to an operation command. Moreover, in accordance with the operation of the operable object, the camera control unit 11b controls the object viewpoint camera so as to follow the operable object. Note that the series of processes (steps S1-3 to S1-8) relating to the operation of the operable object are repeatedly performed.

On the other hand, the camera control unit 11b of the control device 10 also controls the overhead camera concurrently with the above-mentioned control of the object viewpoint camera (step S1-9). The overhead camera is used to capture images of a three-dimensional virtual space without relying on a specific object. As described above, the camera control unit 11b may control the overhead camera so that the overhead camera moves along a predetermined trajectory within the three-dimensional virtual space, for example.

Furthermore, the drawing processing unit 11e of the control device 10 draws a two-dimensional image from the viewpoint of the overhead camera (step S1-10). That is, the drawing processing unit 11e converts the three-dimensional virtual space expressed in the world coordinate system (X, Y, Z) into the screen coordinate system (U, V) from the overhead camera, and generates a two-dimensional image. After that, the first display control unit 11f of the control device 10 outputs the generated two-dimensional image to the projector 31 of the display device 30 via a predetermined I/O interface (step S1-11).

Next, the projector 31 of the display device 30 displays the two-dimensional image input from the control device 10 by projecting the two-dimensional image onto the screen 32 (step S1-12). At this time, an operable object that is operated via the operation terminal 40 may appear in the field of view of the three-dimensional virtual space captured by the overhead camera. In this case, the operable object displayed by the display device 30 will operate in accordance with the operation of the operation terminal 40. In other words, since the operable object that is displayed and operated by the operation terminal 40 and the operable object that is displayed by the display device 30 are the same in the three-dimensional virtual space, it can be said that these objects are synchronized with each other. Note that the series of processes (steps S1-9 to S1-12) for displaying the image from the overhead camera on the display device 30 is repeatedly performed.

FIG. 5 shows an example of the above-mentioned second feature, that is, a process in which the operation terminal 40 performs a reaction when an operable object displayed on the display device 30 is touched. First, the detection device 60 detects the contact position of the user (viewer) on the screen 32 of the display device 30 (step S2-1). The detection device 60 detects the x and y coordinates of the contact position by the viewer on the plane of the screen 32, and outputs this information to the control device 10.

Next, 30, based on the detection information input from the detection device 60, the contact position determination unit 11h of the control device 10 determines whether or not the viewer has touched the operable object displayed on the screen 32 of the display device 30 (step S2-2). Then, when the contact position determination unit 11h has determined that the viewer has touched the operable object, the object control unit 11c controls the operation of the operable object so that the operable object performs a predetermined action within the three-dimensional virtual space (step S2-3). The action of the operable object at this time is not particularly limited, but possible actions include, for example, causing the operable object to vibrate, generating a specified effect around the operable object, causing the operable object to accelerate or decelerate, or causing the operable object to bounce. Note that the action performed by the operable object in response to contact by the viewer may differ depending on the type of the operable object. At this time, the contact position determination unit 11h can also determine whether or not the viewer has contacted a non-operable object. In a case in which it is determined that the viewer has touched a non-operable object, the object control unit 11c may control the operation of the operable object so that the non-operable object performs a predetermined action within the three-dimensional virtual space.

Next, the terminal control unit 11i of the control device 10 specifies the operation terminal 40 that is operating the operable object that is determined to have been contacted by the viewer by the contact position determination unit 11h (step S2-4). As described above, the storage unit 12 of the control device 10 stores an operable object currently existing in the three-dimensional virtual space and the operation terminal 40 that is operating the operable object in association with each other. By referring to this database, the terminal control unit 11i can identify the operation terminal 40 that is operating the operable object that the viewer has touched. After that, the terminal control unit 11i generates a reaction command and transmits the reaction command to the operation terminal 40 specified in this way (step S2-5). The reaction command is basically a command related to drive control of an output unit included in the operation terminal 40. There are no particular limitations on the reaction command; however, possible commands include, for example, a command to perform a display of something on the display screen of the display unit 48 of the operation terminal 40, a command to vibrate the vibrator 49 of the operation terminal 40, a command to output a specified sound from the speaker 51 of the operation terminal 40, and a command to turn on the flashlight 52 of the operation terminal 40. Note that the reaction command transmitted to the operation terminal 40 may differ depending on the type of the operable object. After that, when the control unit 41 of the operation terminal 40 receives a reaction command from the control device 10, the control unit 41 executes a reaction process in accordance with the reaction command (step S2-6). More specifically, the control unit 41 may control output units such as the display unit 48, the vibrator 49, the speaker 51, and the flashlight 52 in accordance with the reaction command.

FIG. 6 shows an example of a process for achieving the third feature mentioned above, that is, capturing an image of an operable object on the display screen of the display device 30 with the imaging unit 45 of the operation terminal 40, thereby enabling the operation of the operable object with the operation terminal 40. In particular, FIG. 6 shows an example of a sequence in which an object drawn or painted by a user is imported into the three-dimensional virtual space and becomes an operable object, allowing the user to operate the operable object that the user created using the user's own operation terminal 40.

First, as shown in FIG. 6, the user scans a printing paper on which an object has been drawn or a printing paper on which an object has been colored by the image capture device 20 (step S3-1). As a result, the image on the printing paper is captured by the image capture device 20. The image data of the printing paper captured by the image capture device 20 is output to the control device 10 via a predetermined I/O interface (step S3-2).

Next, the generation unit 11a of the control device 10 generates an operable object based on the image data input from the image capture device 20 (step S3-3). The process of generating the operable object is as described above. In addition, the generation unit 11a also applies a predetermined operation program to the generated operable object, causing the operable object to appear in the three-dimensional virtual space. As a result, the operable object created by the user performs a predetermined operation in accordance with the operation program within the three-dimensional virtual space. Moreover, as described above, an overhead camera is present in the three-dimensional virtual space, and images from the overhead camera are output in real time to the projector 31 of the display device 30 (step S3-4). The operable object created by the user operates within the three-dimensional virtual space, and thus an image of the operable object may be captured by the overhead camera; however, in that case, the operable object created by the user is projected on the screen 32 by the projector 31 of the display device 30.

Next, the user finds the operable object that the user created from the image displayed on the screen 32, and captures an image of the operable object with the imaging unit 45 of the user's own operation terminal 40 (step S3-5). The control unit 41 of the operation terminal 40 stores the captured image captured by the imaging unit 45 in the storage unit 42, and transmits the captured image to the control device 10 via the communication unit 43 (step S3-6).

Next, the image analysis unit 11j of the control device 10 analyzes the captured image received from the operation terminal 40 via the communication unit 13, and determines whether or not the captured image includes an unoperated operable object (step S3-7). Furthermore, in a case in which the image analysis unit 11j has determined that the captured image includes an operable object, the image analysis unit 11j performs individual identification of the operable object based on features such as the shape and color of the operable object in the captured image (step S3-8).

Next, the object management unit 11d of the control device 10 grants operation authority for the operable object identified by the image analysis unit 11j to the operation terminal 40 that has captured the image of the operable object (step S3-9). More specifically, the identification information (ID) of the operable object and the identification information (IP address, etc.) of the operation terminal 40 are registered in the database of the storage unit 12. As a result, it becomes possible for the user to use the operation terminal 40 to operate the operable object that the user created. The subsequent processing is as described above; however, when the user inputs operation information for an object into the operation terminal 40, the operation command is transmitted from the operation terminal 40 to the control device 10 (step S3-10), and the control device 10 performs control of the operation of the operable object within the three-dimensional virtual space based on the operation command (step S3-11).

In this way, even in a case in which there are numerous operable objects in the three-dimensional virtual space and it is difficult for the user to find the operable object the user created from the list, the user can easily operate the operable object by capturing an image of the operable object the user created with a camera. In addition, the user can have fun searching for an operable object that user has created among the objects displayed on the screen 32.

In the above description of the present invention, the embodiments of the present invention have been described with reference to the drawings in order to express the contents of the present invention. However, the present invention is not limited to the above-described embodiments, and includes modifications and improvements that are obvious to those skilled in the art based on the matters described in this specification.

### REFERENCE SIGNS LIST

10 . . . Control device
11 . . . Central control unit
11a . . . Generation unit
11b . . . Camera control unit
11c . . . Object control unit
11d . . . Object management unit
11e . . . Drawing processing unit
11f . . . First display control unit
11g . . . Second display control unit
11h . . . Contact position determination unit
11i . . . Terminal control unit
11j . . . Image analysis unit
12 . . . Storage unit
13 . . . Communication unit
20 . . . Image capture device
30 . . . Display device
31 . . . Projector
32 . . . Screen
40 . . . Operation terminal
41 . . . Control unit
42 . . . Storage unit
43 . . . Communication unit
44 . . . Input unit
45 . . . Imaging unit
46 . . . Gyro sensor
47 . . . Acceleration sensor
48 . . . Display unit
49 . . . Vibrator
51 . . . Speaker
52 . . . Flashlight
60 . . . Detection device
100 . . . Image display system

1. An image display system comprising
a display device, an operation terminal, a control device connected to the display device and the operation terminal via a wired or wireless network, and an image capture device that scans a physical medium on which an object is drawn and captures image data; wherein
the control device includes:
a generation unit that generates a three-dimensional virtual space and generates an operable object in the three-dimensional virtual space based on the image data;
a camera control unit that controls, in the three-dimensional virtual space, an overhead camera and an object viewpoint camera that is from the perspective of the operable object or that follows the operable object;
a first display control unit that causes the display device to display an image from the overhead camera;
a second display control unit that causes the operation terminal to display an image from the object viewpoint camera; and
an object control unit that controls operation of the operable object in the three-dimensional virtual space.

2. The system according to claim 1 further comprising
a detection device capable of detecting a contact position on a display screen of the display device, wherein
the control device further includes a terminal control unit that generates a reaction command based on detection information by the detection device and transmits the reaction command to the operation terminal; and
the operation terminal includes an output unit that performs an output in response to the reaction command.

3. The system according to claim 2, wherein
when the terminal control unit has determined that a contact position detected by the detection device corresponds to the operable object displayed on the display screen, the terminal control unit generates the reaction command for the operation terminal that is operating the operable object.

4. The system according to claim 1, wherein
the operation terminal includes an imaging unit, and transmits a captured image captured by the imaging unit to the control device;
the control device further includes:
an image analysis unit that analyzes the captured image and determines whether the captured image includes the operable object; and
an object management unit that grants operation authority to the operation terminal that has captured the image of the operable object for enabling the operable object to be operated when the captured image is determined to include the operable object; and
the object control unit controls operation of the operable object in the three-dimensional virtual space in accordance with an operation command from the terminal device to which the operation authority has been granted.

5. A control device connected, via a wired or wireless network, to a display device, an operation terminal, and an image capture device that scans a physical medium on which an object is drawn and captures image data, the control device comprising:
a generation unit that generates a three-dimensional virtual space and generates an operable object in the three-dimensional virtual space based on the image data;
a camera control unit that controls, in the three-dimensional virtual space, an overhead camera and an object viewpoint camera that is from the perspective of the operable object or that follows the operable object;
a first display control unit that causes the display device to display an image from the overhead camera;
a second display control unit that causes the operation terminal to display an image from the object viewpoint camera; and
an object control unit that controls operation of the operable object in the three-dimensional virtual space.

6. The control device according to claim 5, wherein
the control device is further connected, via a wired or wireless network, to a detection device capable of detecting a contact position on a display screen of the display device;
the control device further includes a terminal control unit that generates a reaction command based on detection information by the detection device and transmits the reaction command to the operation terminal; and
the control device causes the operation terminal to perform an output in response to the reaction command.

7. The control device according to claim 6, wherein
when the terminal control unit has determined that a contact position detected by the detection device corresponds to the operable object displayed on the display screen, the terminal control unit generates the reaction command for the operation terminal that is operating the operable object.

8. The control device according to claim 5, wherein
the operation terminal includes an imaging unit, and transmits a captured image captured by the imaging unit to the control device;
the control device further includes:
an image analysis unit that analyzes the captured image and determines whether the captured image includes the operable object; and
an object management unit that grants operation authority to the operation terminal that has captured the image of the operable object for enabling the operable object to be operated when the captured image is determined to include the operable object; and
the object control unit controls operation of the operable object in the three-dimensional virtual space in accordance with an operation command from the terminal device to which the operation authority has been granted.

9. A computer program for causing a computer to function as the control device according to claim 5.

10. An image display method executed by a system including a display device, an operation terminal, a control device connected to the display device and the operation terminal via a wired or wireless network, an image capture device that scans a physical medium on which an object is drawn and captures image data, and a detection device that can detect a contact position on a display screen of the display device; the image display method comprising steps of:
the control device generating a three-dimensional virtual space, and generating an operable object in the three-dimensional virtual space based on the image data;
the control device controlling, in the three-dimensional virtual space, an overhead camera and an object viewpoint camera that is from the perspective of the operable object or that follows the operable object;
causing the control device to display an image from the overhead camera on the display device;
causing the control device to display an image from the object viewpoint camera on the operation terminal; and
the control device controlling operation of the operable object in the three-dimensional virtual space.

11. The image display method according to claim 10, further comprising steps of:
generating a reaction command based on detection information by the detection device and transmitting the reaction command to the operation terminal by the control device; and
performing an output in response to the reaction command by the operation terminal.

12. The image display method according to claim 11, wherein
the step of transmitting the reaction command to the operation terminal is a step in which, when the control device has determined that a contact position detected by the detection device corresponds to the operable object displayed on the display screen, the control device generates a reaction command for the operation terminal that is operating the operable object, and transmits the reaction command to the operation terminal.

13. The image display method according to claim 10, comprising steps of:
transmitting a captured image captured by an imaging unit to the control device by the operation terminal;
analyzing the captured image and determining whether or not the captured image includes the operable object by the control device;
granting an operation authority to the operation terminal that has captured the image of the operable object so that the operable object can be operated by the control device when the captured image is determined to include the operable object; and
controlling operation of the operable object in the three-dimensional virtual space in accordance with an operation command from the operation terminal to which the operation authority is granted by the control device.
